(19) United States
(12) Patent Application Publication
(10) Pub. No.: US 2025/0017167 A1
(43) Pub. Date: Jan. 16, 2025

(54) EQUIPMENT FOR THE PRODUCTION OF STUFFED CHEESE, PARTICULARLY BURRATA CHEESE

(71) Applicant: Carmine MAROTTA, Ravarino (MO) (IT)

(72) Inventor: Carmine MAROTTA, Ravarino (MO) (IT)

(21) Appl. No.: 18/711,170

(22) PCT Filed: Nov. 16, 2022
(86) PCT No.: PCT/IB2022/061035

§ 371 Date: May 17, 2024

(30) Foreign Application Priority Data
Nov. 19, 2021 (IT) 102021000029345

(51) Int. Cl. A01J 25/12; A01J 25/00; A23C 19/068; A23C 19/09

(52) U.S. Cl. CPC A01J 25/12; A01J 25/008; A23C 19/0684; A23C 19/0908

(57) ABSTRACT

The equipment (1) comprises:
supporting means (3) adapted to support at least one cheese (C) of the fresh “pasta filata” type;
gripping means (6) adapted to retain at least one portion (P) of the cheese (C);
filling means (7) adapted to inject a filling into the cheese (C) through said portion (P) to obtain a stuffed cheese(S);
at least one automated positioning system (19) adapted to pick up the cheese (C) from a supply station (E) and to transfer it onto the supporting means (3), wherein the automated positioning system (19) comprises:
   one retaining and holding assembly (28) for the cheese (C);
   one displacement unit (29) adapted to move the retaining and holding assembly (28) between the supply station (E) and the supporting means (3).

### TECHNICAL FIELD

The present invention relates to a piece of equipment for the production of stuffed cheese, particularly burrata cheese.

### BACKGROUND ART

Burrata cheese is a fresh “pasta filata” cheese, usually pouch-shaped, containing a filling consisting of fresh cheese shavings and cream, also called stracciatella.

The burrata production process is manual and involves initial working of the hot spun cheese paste in order to obtain a substantially spheroidal fresh cheese, called mozzarella.

The mozzarella is then held, through a small portion, by an operator, who fits an injector to dispense the filling inside the mozzarella itself.

During dispensing, the mozzarella deforms to make room for the filling and acquires the characteristic pouch shape.

Also during these operations, it is important that the mozzarella cheese maintains a high temperature in order to preserve the elasticity and deformability of the paste and allow the injection of the filling while avoiding tears and/or breakage.

Specifically, the cheese is worked at a temperature between 50° C. and 70° C.

Once this operation has been completed, the operator seals the portion by applying a pressing force thereon; through this operation, the portion can eventually be removed from the burrata cheese depending on the shape to be given thereto.

Finally, the resulting burrata cheese is cooled and packaged.

It is easy to appreciate that this process is particularly labor-intensive and requires the use of skilled labor, as it is necessary that the operations be carried out precisely and accurately to prevent the “pouch” from being damaged, thusu jeopardizing the work thereof.

In addition, it is easy to appreciate that the handling of cheese at high temperatures by an operator is a rather unpleasant operation and, moreover, detrimental to the operator's health and can cause the operator to grasp the cheese improperly, thus risking jeopardizing its elastic properties and/or the aesthetic appearance of the finished stuffed cheese.

This results in an inevitably high cost of production and, consequently, high prices for the end consumer.

Again, manual work implies rather long working times that can affect the quality of fresh cheese which, in order to maintain its quality almost unchanged, need to be placed on the market within a short time after production.

Finally, the risk of contamination related to the manual work of such fresh cheese should not be underestimated which may, in turn, affect the quality of the finished product. It is important to point out that the alterations in the quality of such fresh cheese greatly affect the degree of customer satisfaction, who may be discouraged from purchasing the product again.

The aforementioned drawbacks are partly fixed by the equipment for the production of stuffed cheese described by WO2021021094839A1.

Such known equipment is of an automated type and comprises supporting means of the fresh “pasta filata” cheese, gripping means adapted to hold a portion of the cheese and filling means adapted to inject a filling inside the cheese through the portion so as to obtain the stuffed cheese.

Thus, the equipment described by WO2021021094839A1 enables automated production of the stuffed cheese and provides for the operator only positioning the cheese on the supporting means. Then, the cheese is transferred in an automated manner between the various working stations until the stuffed cheese is obtained.

However, the cheese positioning operation is also affected by the above issues, and known equipment is itself susceptible to refinements.

### DESCRIPTION OF THE INVENTION

The main aim of the present invention is to devise a piece of equipment for the production of stuffed cheese, particularly burrata cheese, which is safe for the operators and allows freedom from the use of skilled labor.

Another object of the present invention is to devise a piece of equipment for the production of stuffed cheese, particularly burrata cheese, which allows reducing working time and the costs related thereto.

A further object of the present invention is to devise a piece of equipment for the production of stuffed cheese, particularly burrata cheese, which will minimize the risk of bacterial contamination.

Another object of the present invention is to devise a piece of equipment for the production of stuffed cheese, particularly burrata cheese, which can overcome the aforementioned drawbacks of the prior art within the framework of a simple, rational, easy and effective to use as well as inexpensive solution.

The aforementioned objects are achieved by this piece of equipment for the production of stuffed cheese, particularly burrata cheese, having the characteristics of claim 1.

### BRIEF DESCRIPTION OF THE DRAWINGS

Other characteristics and advantages of the present invention will become more apparent from the description of a preferred, but not exclusive, embodiment of a piece of equipment for the production of stuffed cheese, particularly burrata cheese, illustrated by way of an indicative, yet non-limiting example, in the accompanying tables of drawings in which:

FIG. 1 is an axonometric view of the equipment according to the invention;

FIG. 2 is an axonometric view of the automated positioning system according to the invention;

FIGS. 3 and 4 are detailed views of the retaining and holding assembly according to the invention;

FIGS. 5 and 6 are schematic representations of the retaining means in accordance with two alternative embodiments;

FIGS. 7-9 are axonometric views of the automated positioning system in different operating positions;

FIG. 10 is an axonometric view of the equipment according to the invention at a different angle;

FIG. 11 is an exploded view of a component of the equipment according to the invention;

FIGS. 12-15 are schematic representations of the equipment according to the invention in different configurations of use;

FIG. 16 is a front view of the equipment according to the invention.

### EMBODIMENTS OF THE INVENTION

With particular reference to these figures, reference numeral 1 globally denotes a piece of equipment for the production of stuffed cheese, particularly burrata cheese.

The equipment 1 comprises at least one base frame 2 and supporting means 3 of at least one “pasta filata” cheese C, associated with the base frame 2.

In particular, the cheese C is of the type of a mozzarella.

It cannot however be ruled out the possibility of using a different type of “pasta filata” cheese, e.g., scamorza.

The cheese C is worked hot to allow the introduction of a filling to obtain a stuffed cheese S, in this case a burrata cheese.

Specifically, the filling comprises one or more fresh dairy products, specifically, mozzarella shavings and cream. The use of different types of dairy products (e.g., ricotta, butter, gorgonzola, etc.) and/or added with non-dairy ingredients (truffles, olives, ham, vegetables, etc.) cannot however be ruled out in the production of stuffed cheese S of different types.

For this purpose, the piece of equipment 1 also comprises:
gripping means 6 of the cheese C associated with the base frame 2 and adapted to retain at least one portion P of the cheese C; and
filling means 7 of the cheese C associated with the base frame 2 and adapted to inject a filling into the cheese C through the portion P to obtain a stuffed cheese S.

The gripping means 6 and the filling means 7 will be described in more detail later in this disclosure.

Usefully, the supporting means 3 comprise a supporting plane 4 movable on the base frame 2 along a direction of forward movement D.

In the embodiment shown in the figures, the supporting plane 4 is of the type of a conveyor belt and the direction of forward movement D is substantially linear.

It cannot, however, be ruled out the possibility that the supporting plane 4 may be of the type of a revolving carousel with a substantially circular direction of forward movement D.

Embodiments cannot also be ruled out wherein the supporting plane 4 be fixed and wherein the cheese C is transferred between the different working stations manually by an operator.

The supporting means 3 also comprise at least one container element 5 of the cheese C associated with the supporting plane 4 and adapted to accommodate the cheese C.

In the present case, the container element 5 is of the type of a cup and is provided with a housing 5a of the cheese C and with a stem 5b that helps to distance the housing itself from the supporting plane 4.

The container element 5 may be made, e.g., of a thermally insulating material so that the temperature of the cheese C can be effectively maintained.

Alternatively, the container element 5 can be made of a metal material, which is characterized by minimal thermal resistance and able to quickly reach the temperature of the cheese C.

The movement of the supporting plane 4 is of the discrete type and allows the positioning of the container element 5 between a loading station of the cheese C, a filling station of the cheese C and an unloading station of the stuffed cheese S.

Specifically, at the loading station, the cheese C is placed inside the housing 5a of the container element 5.

At the filling station, the gripping means 6 and the filling means 7 are arranged.

Usefully, the supporting means 3 comprise a plurality of container elements 5 associated with the supporting plane 4 and adapted to house a plurality of cheese C.

The container elements 5 are arranged in succession along the direction of forward movement D. Specifically, the container elements 5 are arranged along at least one row of container elements F substantially parallel to the direction of forward movement D.

In more detail, the container elements 5 are arranged on the supporting plane 4 at predefined distances, so that when a container element 5 is at the unloading station, there is a following one arranged at the filling station.

Such an embodiment solution allows the stuffed cheese S to be produced in a continuous cycle and without the need for the container element 5 to unload the stuffed cheese S before a new cycle begins.

In accordance with the embodiment shown in the figures, the supporting means 3 comprise a plurality of container elements 5 at least partly arranged side by side along at least one positioning direction B which is transversal to the direction of forward movement D.

Preferably, the positioning direction B is substantially orthogonal to the direction of forward movement D.

Alternative embodiments cannot however be ruled out wherein the positioning direction B is inclined with respect to the direction of forward movement D.

Specifically, the container elements 5 are arranged on the supporting plane 4 in several rows of container elements F side by side along respective positioning directions B.

In more detail, the rows of container elements F are arranged substantially parallel to each other.

The container elements 5 are, therefore, arranged so that when a container element 5 from one of the rows of container elements F is at the loading station, the other rows of container elements F also have a container element 5 at the same station. As can easily be seen, the same considerations can be made for all stations.

Thus, the piece of equipment 1 allows a plurality of cheese C to be worked simultaneously.

According to the invention, the piece of equipment 1 comprises at least one automated positioning system 19 associated with the base frame 2 and adapted to pick up the cheese C from a supply station E and to transfer it onto the supporting means 3.

In the context of this disclosure, the term “supply station” is used to refer to an area where the cheese C is arranged waiting to be picked and subjected to filling.

In the figures, the supply station E is defined on a forming machine, known to the technician in the field, and the automated positioning system 19 is, therefore, configured to directly pick up the freshly prepared cheese C from the forming machine itself.

Specifically, the forming machine comprises a plurality of supply stations E each adapted to contain a respective cheese C.

In this regard it should be noted that, in accordance with a possible embodiment, the forming machine can be part of the piece of equipment 1.

It cannot, however, be ruled out that the supply station E be defined on a different type of device, e.g. the type of a collecting basin or the like.

The automated positioning system 19 is then adapted to place the cheese C on a relevant container element 5 arranged at the loading station.

As stated above, the cheese C must be worked while hot in order to preserve the elasticity and deformability of the paste and allow it to be stuffed while avoiding tearing and/or breaking.

Specifically, the cheese C is worked at a temperature between 50° C. and 70° C.

It is easy to appreciate how, at such temperatures, the handling of the cheese C by an operator is a rather unpleasant operation and detrimental to the operator's health, and may cause the operator to grasp the cheese C improperly, risking jeopardizing its elastic properties and/or appearance.

Thus, the automated positioning system 19 allows avoiding the handling of the cheese C at such temperatures by the operator, thus making the equipment extremely safe for the operators.

In addition, the automated positioning system 19 allows speeding up the positioning operation and avoiding overcooling of the cheese C.

Again, the presence of the automated positioning system 19 helps improve the hygienic conditions of the finished product.

In detail, the automated positioning system 19 comprises:
at least one retaining and holding assembly 28 of the cheese C;
at least one displacement unit 29 adapted to move the retaining and holding assembly 28 between the supply station E and the supporting means 3.

The retaining and holding assembly 28 allows the cheese C to be firmly grasped and held, thus preventing any accidental fall of the latter.

On the other hand, the displacement unit 29 is responsible for the actual displacement of the cheese C towards the supporting means 3.

Advantageously, the retaining and holding assembly 28 comprises:
at least one base support 30 associated with the displacement unit 29; and
retaining means 31 associated with the base support 30 and adapted to grasp an upper part of the cheese C.

The retaining and holding assembly 28 also comprises holding means 32 associated with the base support 30 and adapted to hold and support a lower part of the cheese C once grasped by the retaining means 31.

It cannot, however, be ruled out that the retaining and holding assembly 28 comprise the retaining means 31 alone.

The retaining means 31 and the holding means 32 are associated with the displacement unit 29 by interposition of the base support 30.

In this case, the base support 30 is of the type of, e.g., a metal plate.

The base support 30 allows the retaining means 31 and the holding means 32 to move simultaneously between the supply station E and the supporting means 3.

The retaining means 31 comprise at least two jaw elements 34 mutually movable towards a common centre H along a relevant centripetal direction of movement L.

In particular, the centripetal direction of movement L is substantially straight and horizontal.

Thus, the jaw elements 34 move mutually close to each other to retain the cheese C and mutually away from each other to release the cheese itself.

In more detail, the jaw elements 34 are arranged substantially equidistant from the common centre H and are movable simultaneously with respect thereto.

The jaw elements 34 are protruding with respect to the base support 30. In more detail, in use, the jaw elements 34 extend downwards so as to easily grasp the upper part of the cheese C.

In addition, the jaw elements 34 have a contact surface adapted to contact the cheese C, which is knurled in shape so as to increase the grip of the cheese itself.

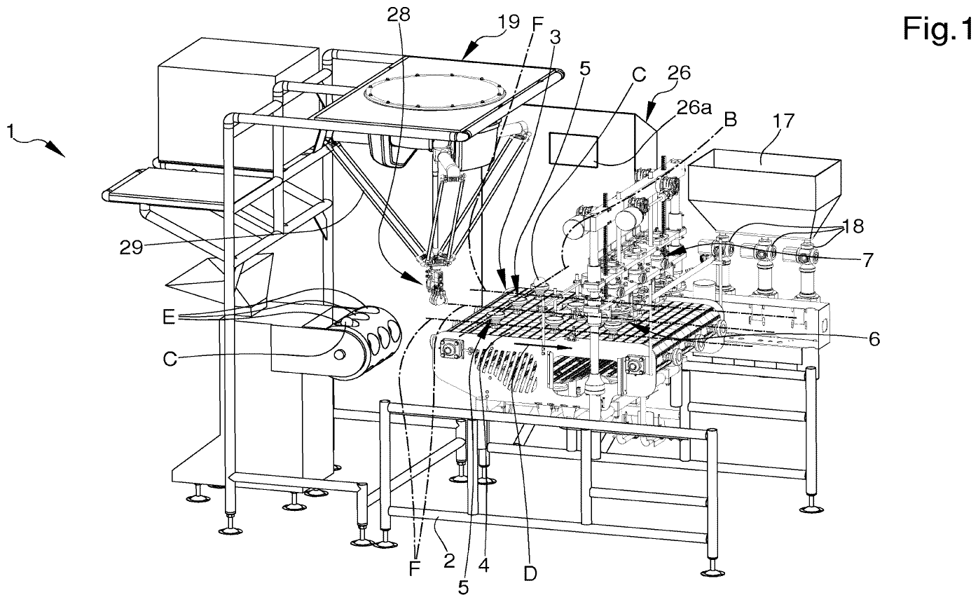

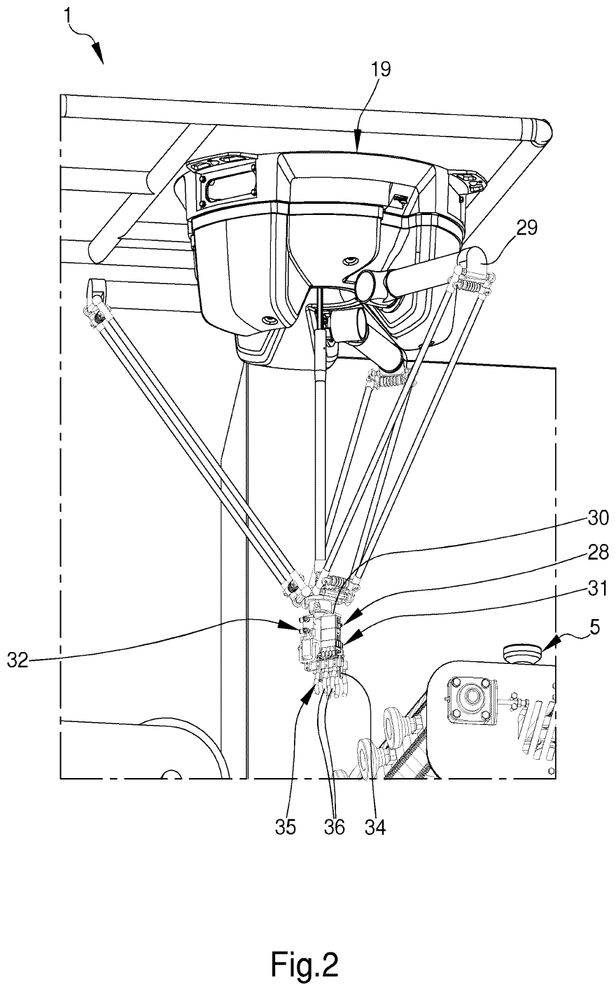

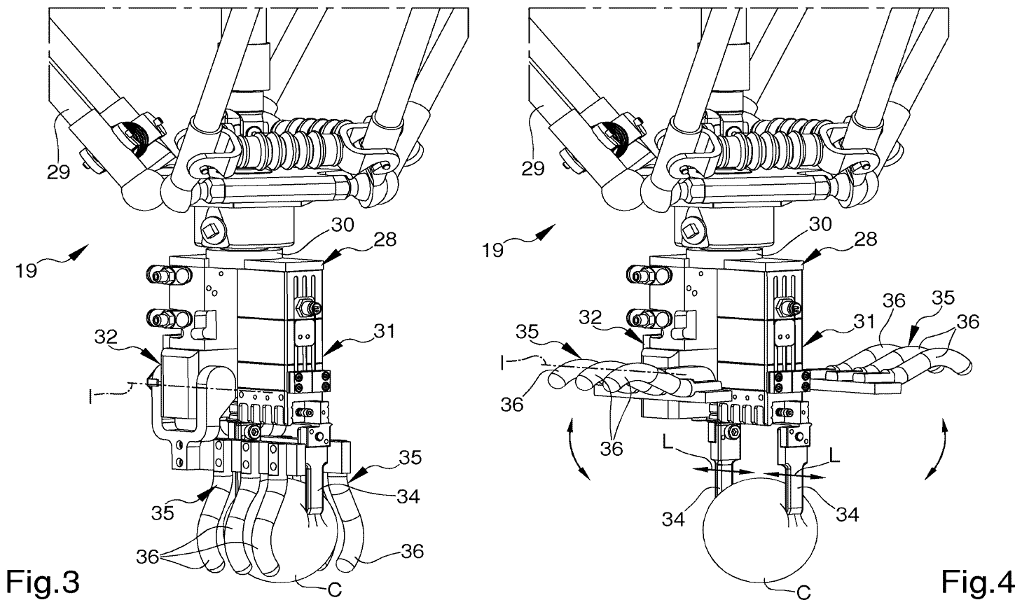

In accordance with the embodiment shown in FIGS. 1 to 5 and 7 to 9, the retaining means 31 comprise two of the jaw elements 34 arranged on opposite sides with respect to the common centre H.

In other words, the jaw elements 34 are arranged facing each other, with the relevant contact surfaces 34 facing each other.

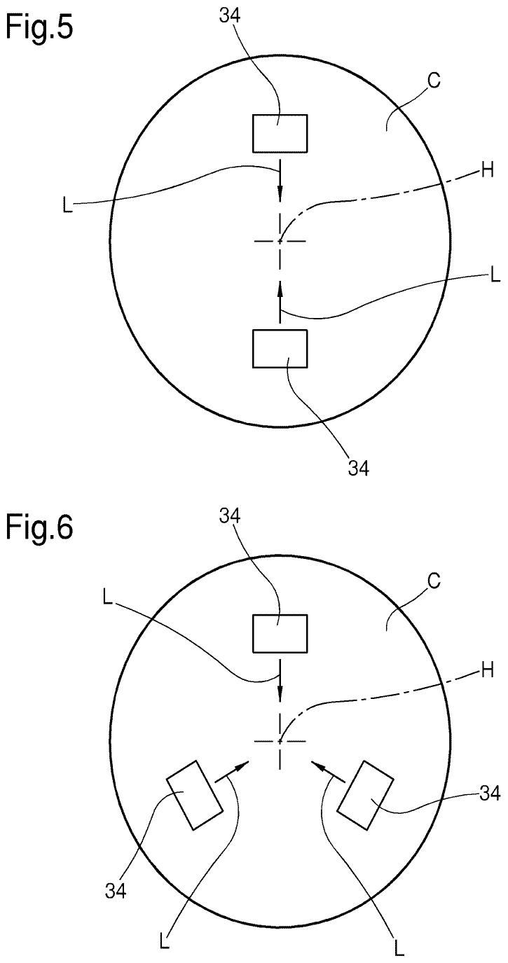

Such an embodiment solution requires that the centripetal directions of movement L are substantially aligned to each other and have opposite directions (FIG. 5).

Preferably, the retaining means 31 comprise a parallel gripper supporting the jaw elements 34.

In accordance with an alternative embodiment, schematically shown in FIG. 6, the retaining means 31 comprise three of the jaw elements 34 arranged around the common centre H at angles substantially equal to 120°.

Such an embodiment provides for the centripetal directions of movement L to be inclined to each other at angles substantially equal to 120°.

The jaw elements 34 are substantially movable with respect to the common centre H in a radial pattern.

In this case, the retaining means 31 comprise a self-centering gripper supporting the jaw elements 34.

As stated above, the retaining and holding assembly 28 also comprises the holding means 32, which enable the cheese C to be supported during handling and prevent possible accidental falling of the same.

Usefully, the holding means 32 comprise at least one shell body 35 rotatable around a substantially horizontal hinge axis I.

The shell body 35 defines a concavity adapted to receive the cheese C in the event of a fall.

The shell body 35 is rotatable between a closing position, wherein it is moved close to the jaw elements 34 and is arranged underneath the lower part of the cheese C, and an opening position, wherein it is spaced apart from the jaw elements 34 and is adapted to release the cheese C.

In more detail, in the closing position, the shell body 35 is arranged with the concavity facing the jaw elements 34 and prevents the cheese C from falling, while in the opening position, the shell body 35 is rotated with respect to the closing position to allow the cheese C to be gripped from the supply station E or the cheese C to be released on the supporting means 3.

Advantageously, the holding means 32 comprise at least two of the shell bodies 35 rotatable around the relevant hinge axes I between the closing position and the opening position, wherein the hinge axes I are substantially parallel to each other.

In the closing position, the shell bodies 35 face each other and define the concavity adapted to receive the cheese C while, in the opening position, they are rotated substantially by 90° with respect to the closing position.

In the closing position, the shell bodies 35 at least partly surround the cheese C.

Appropriately, the shell bodies 35 comprise an inner surface which, in the closing position, is spaced away from the cheese C. In other words, the shell bodies 35 do not contact the cheese C, so as to avoid deformation and/or alteration of the appearance thereof. If the cheese C is accidentally released from the retaining means 31, the holding means 32 prevent it from falling.

It is however possible that, as a result of the movement of the retaining and holding assembly 28, the cheese C may become deformed and, in such a case, the inner surface of the shell bodies 35 may define a resting base for the cheese itself.

Preferably, the holding means 32 comprise an angular gripper supporting the shell bodies 35.

In accordance with the embodiment shown in the figures, the hinge axes I are arranged substantially parallel to the centripetal directions of movement L of the jaw elements 34. In this way, the movement of the shell bodies 35 does not interfere with the movement of the jaw elements 34.

Again with reference to the embodiment shown in the figures, each shell body 35 comprises a plurality of holding elements 36 spaced apart from each other, of curved conformation and partly defining the concavity.

The holding elements 36 thus define an open concavity that allows the flow of any work liquids of the cheese C and allows visual monitoring the transfer process.

Usefully, the displacement unit 29 is provided with at least three degrees of freedom and comprises at least one articulated arm associated with the base frame 2 and supporting the base support 30.

In more detail, the displacement unit 29 is associated with the base frame 2 above the supporting means 3.

In this way, the displacement unit 29 is able to easily move the retaining and holding assembly 28 while avoiding getting in the way of further components of the piece of equipment 1.

In addition, such an arrangement allows the overall dimensions of the piece of equipment 1 to be greatly reduced.

In accordance with the embodiment shown in the figures, the displacement unit 29 comprises a delta robot.

As known to the engineer in the field, a delta robot is a type of parallel robot that provides for the use of arms made in the shape of a parallelogram, capable of maintaining the orientation of the end. In other words, the displacement unit 29 allows moving the retaining and holding assembly 28 along the three Cartesian axes but it prevents the same from rotating.

The delta robot enables extremely rapid movement of the cheese C, thus preventing the cheese itself from cooling excessively.

In addition, unlike other types of automated devices, the delta robot makes it possible to achieve remarkably large work volumes while maintaining extremely small overall dimensions.

It cannot, however, be ruled out that the displacement unit 29 comprise a different type of automated device, e.g., of the type of an anthropomorphic robotic arm or a collaborative robot.

Usefully, the equipment 1 comprises at least one electronic unit 26a programmable with at least one position of the supply station E and with at least one position of at least one of the container elements 5 at the loading station.

The electronic unit 26a is operatively connected to the automated positioning system 19 and is configured to operate the displacement unit 29 depending on the aforementioned positions.

Once placed on the container element 5, the cheese C is conveyed to the gripping means 6.

The gripping means 6 comprise at least one gripping frame 8 associated with the base frame 2 and at least one diaphragm device 9, associated with the gripping frame 8 and closable around the cheese C to retain the portion P and openable to release the stuffed cheese S.

Specifically, the diaphragm device 9 defines a passage hole 10 through which the cheese C can transit.

Closing the diaphragm device 9 results in a gradual occlusion of the passage hole until the cheese C is intercepted.

Advantageously, the diaphragm device 9 comprises a plurality of gripping elements 11 associated with the gripping frame 8, arranged along a circumference.

Specifically, the gripping elements 11 are arranged to surround the passage hole 10 and are mutually movable in rotation around their respective axes of rotation R between at least one position of work, wherein they are moved close to the centre of the circumference to intercept the cheese C and hold the portion P and, at least one home position, wherein they are moved away from the centre to release the cheese C.

In other words, the gripping elements 11 move concentrically at the same time to intercept the portion P and keep the cheese C stationary.

The diaphragm device 9 is, in addition, provided with rotational means 12 of the gripping elements 11 between at least the position of work and the home position, comprising at least one connecting element 13 associated with the gripping elements 11.

The connecting element 13 has a substantially circular shape, is arranged above the gripping elements 11 and comprises a plurality of slots 13a, arranged along the circumference, each associated with a corresponding pin 11a defined on a respective gripping element 11.

In more detail, the pin 11a is housed inside the slot 13a in a sliding manner, the shape of which determines the movement trajectory of the pin 11a and thus the amplitude of rotation of the gripping element 11 around its respective axis of rotation R.

The rotational means 12 comprise at least one actuating body 14 operatively connected to the connecting element 13 by means of a gear wheel 14a adapted to mesh on a respective toothed portion 13b defined on the connecting element itself.

The rotation of the gear wheel 14a in the two directions of rotation determines the movement of the gripping elements 11 between the position of work and the home position.

Specifically, the rotation of the connecting element 13 causes the slots 13a to be displaced, which in turn drag the respective pins 11a and transfer the movement to the gripping elements 11.

Appropriately, the gripping elements 11 are, in addition, movable towards a position of sealing wherein the passage hole 10 is further occluded and wherein the gripping elements 11 exert a pressing force on the portion P in order to firmly close the stuffed cheese S.

At the end of this operation, the stuffed cheese S has a sealing area that divides the portion P from the stuffed part below.

The gripping elements 11 are, moreover, further movable towards a cutting position wherein the passage hole 10 is completely occluded; in the cutting position, the gripping elements 11 cause the detachment of the portion P from the stuffed cheese S.

In fact, the piece of equipment 1 allows the production of stuffed cheese S provided with the characteristic “pouch” shape and/or of stuffed cheese S with a spheroidal shape, wherein the portion P is removed from the stuffed cheese S.

Following detachment, the portion P remains on the diaphragm device 9 until the next movement of the gripping elements 11 towards the home position, wherein it is deposited on the supporting plane 4 by gravity.

Usefully, the piece of equipment 1 can comprise a plurality of diaphragm devices 9, arranged one above the other and operable independently depending on the type of stuffed cheese S to be obtained.

For example, based on the size of the stuffed cheese S to be made, two diaphragm devices 9 may be used that are equal to each other; in fact, in the case of one wishes to produce a small-sized stuffed cheese S, only one diaphragm device 9 is operated in order to retain a small portion P; whereas, for the production of a large-sized stuffed cheese S, it will be necessary to retain a larger portion P and both diaphragm devices 9 will be operated at the same time.

Alternatively or in combination thereof, one of the diaphragm devices 9 may comprise gripping elements 11 provided with a cutting portion adapted to remove the portion P in an easy manner following the filling of the cheese C; in this case, the piece of equipment 1 comprises at least one diaphragm device 9 adapted to seal the portion P and at least one diaphragm device 9 adapted to remove it.

Alternatively or in combination with the diaphragm device 9, the gripping means 6 may comprise a gripper device associated with the gripping frame 8 and movable to retain and/or seal the cheese C and/or to remove the portion P from the stuffed cheese S.

In accordance with the embodiment shown in the figures, the gripping means 6 comprise a plurality of diaphragm devices 9 associated with the gripping frame 8 and arranged side by side along at least one working direction W parallel to the positioning direction B.

Each of the diaphragm devices 9 is adapted to retain a respective cheese C.

Specifically, the number of diaphragm devices 9 corresponds to the number of rows of container elements F.

Usefully, each diaphragm device 9 comprises a respective actuating body 14.

The diaphragm devices 9 can, therefore, be operated independently of each other to retain/release the cheese C.

In this way, only those actually needed diaphragm devices 9 can be operated.

In addition, it can be provided that in some diaphragm devices 9 the gripping elements 11 are moved between the home position and the sealing position, while in other diaphragm devices 9 the gripping elements 11 are moved between the home position and the cutting position, to obtain stuffed cheese S provided with the portion P and without the same, respectively.

As anticipated above, the piece of equipment 1 comprises the filling means 7 which are adapted to inject the filling in the cheese C.

The filling means 7 comprise at least one filling frame 15 associated with the base frame 2 and at least one injector device 16 associated with the filling frame 15 and adapted to inject the filling in the cheese C.

Usefully, the piece of equipment 1 also comprises at least one tank 17 adapted to contain the filling, connected to the injector device 16 in a fluid-operated manner, and at least one pumping device 18 adapted to transfer the filling from the tank 17 to the injector device 16.

In more detail, the injector device 16 is partly inserted into the cheese C through the portion P, properly retained by the gripping means 6, and dispenses the filling, contained in the tank 17, in the cheese C.

In accordance with the embodiment shown in the figures, the filling means 7 comprise a plurality of injector devices 16 connected to the tank 17 in a fluid-operated manner, associated with the filling frame 15 and arranged side by side along at least one operating direction G transversal to the direction of forward movement D.

Preferably, the operating direction G is substantially orthogonal to the direction of forward movement D.

Advantageously, the operating direction G is substantially parallel to the working direction W.

Even more preferably, the operating direction G and the working direction W extend substantially horizontally and lie above each other in the same substantially vertical plane.

Appropriately, each diaphragm device 9 corresponds to an injector device 16.

Each of the injector devices 16 is adapted to inject the filling in a respective cheese C.

Usefully, each injector device 16 is connected to a respective pumping device 18.

The injector devices 16 can, therefore, be operated independently of each other to dispense filling.

In this way, each injector device 16 dispenses filling only if it is actually needed, i.e., if the corresponding diaphragm device 9 has closed to retain the cheese C.

In addition, the injector devices 16 can be expected to dispense different amounts of filling so that the stuffed cheese S of different types can be obtained.

Thus, the piece of equipment 1 allows both working several cheese C simultaneously and producing stuffed cheese S of different types.

Following filling, the injector device 16 is pulled out of the portion P to obtain the stuffed cheese S and the gripping means 6 seal and possibly remove the portion P.

The stuffed cheese S thus obtained is released from the gripping means 6 and transferred towards the unloading station; in particular, the gripping elements 11 are moved towards the home position to release the passage hole 10.

During this operation, any removed portion P is released onto the supporting plane 4 to allow it, together with the stuffed cheese S, to be moved away from the filling station towards the unloading station.

The stuffed cheese S and any detached portion P are then moved away from the piece of equipment 1 by means of methods known to the technician in the field.

The piece of equipment 1 comprises movement means 20, 21 adapted to move at least one of the supporting means 3, the gripping means 6 or the filling means 7.

In more detail, the movement means 20, 21 are adapted to mutually move the supporting means 3, the gripping means 6 and the filling means 7 during the gripping and filling phases.

Advantageously, the piece of equipment 1 comprises at least one mutual movement unit 20 associated with the base frame 2 and adapted to mutually move the supporting means 3 and the gripping means 6, and at least one mutual movement assembly 21 associated with the base frame 2 and adapted to mutually move the gripping means 6 and the filling means 7.

The mutual movement unit 20 is adapted to move at least one of either the supporting means 3 or the gripping means 6 with respect to the other along an axis of travel A1 substantially perpendicular to the supporting plane 4.

The function of the mutual movement unit 20 is substantially to bring the supporting means 3 and the gripping means 6 closer or farther away from each other to enable the cheese C to be retained by the diaphragm device 9.

In the embodiment shown in the figures, the mutual movement unit 20 is adapted to move the gripping means 6 with respect to the supporting means 3.

The mutual movement unit 20 has, in addition, the function of moving the diaphragm device 9 away from the container element 5 during filling by the filling means 7.

During this phase, in fact, the cheese C tends to deform to make room for the filling, thus increasing its volume.

The mutual movement unit 20 comprises a driving unit 22a, 22b operatively connected to the gripping frame 8 and a guidance unit 23 associated with the base frame 2 and extending along the axis of travel A1.

The gripping frame 8 is associated with the guidance unit 23 by sliding.

The driving unit 22a, 22b comprises a rack-and-pinion element 22a, associated with the gripping frame 8, substantially parallel to the guidance unit 23, and an actuating device 22b, of the type of an electric motor, connected to the rack-and-pinion element itself and adapted to move the gripping frame 8 on the guidance unit 23.

The mutual movement assembly 21 is adapted to move at least one of either the gripping means 6 or the filling means 7 with respect to the other along an axis of sliding A2 substantially perpendicular to the supporting plane 4.

In other words, the function of the mutual movement assembly 21 is to bring the filling means 7 and the gripping means 6 closer or farther apart from each other to enable the insertion and the extraction of the injector device 16 into/from the portion P.

In the embodiment shown in the figures, the mutual movement assembly 21 is adapted to move the filling means 7 with respect to the gripping means 6.

The mutual movement assembly 21 has, in addition, the function of moving the injector device 16 from the container element 5 during filling, substantially at the same time as the gripping means 6, to facilitate the deformation of the cheese C.

The mutual movement assembly 21 comprises a motor assembly 24a, 24b operatively connected to the filling frame 15 and a guidance assembly 25 associated with the base frame 2 and extending along the axis of sliding A2.

The filling frame 15 is associated with the guidance assembly 25 by sliding.

The motor assembly 24a, 24b comprises at least one rack-and-pinion body 24a, associated with the filling frame 15, substantially parallel to the guidance assembly 25, and an actuating element 24b, of the type of an electric motor, connected to the rack-and-pinion body itself and adapted to move the filling frame 15 on the guidance assembly 25.

Usefully, the guidance assembly 25 coincides with the guidance unit 23 and the axis of sliding A2 coincides with the axis of travel A1.

In other words, the filling frame 15 and the gripping frame 8 are arranged above each other, mounted on the same guides and moving along the same axis with respect to the supporting means 3.

In particular, the expedient of providing that the plurality of diaphragm devices 9 be associated with a single gripping frame 8 and that the plurality of injector devices 16 be associated with a single filling frame 15 allows the simultaneous movement of the same by means of the driving unit 22a, 22b and the motor assembly 24a, 24b, respectively.

Such an embodiment solution allows reducing the number of components and moving parts, thus making the piece of equipment 1 extremely compact and provided with agile operation.

In addition, the equipment 1 comprises an electronic control system 26 provided with the electronic unit 26a.

The electronic unit 26a is further configured to operate at least one of either the supporting means 3, the gripping means 6, the filling means 7, the mutual movement unit 20 or the mutual movement assembly 21.

The piece of equipment 1 also comprises at least one presence sensor 27 configured to detect the presence of the cheese C inside the container element 5.

In more detail, the presence sensor 27 is configured to detect the presence of the cheese C with the container element 5 positioned at a detection station, located between the loading station and the filling station.

The presence sensor 27 is of the type, e.g., of a direct diffusion photocell.

The injector device 16 is enslaved to the presence sensor 27 to dispense the filling only when the cheese C is present in the container element 5.

Specifically, the piece of equipment 1 comprises a presence sensor 27 for each injector device 16.

The presence sensors 27 are operatively connected to the electronic unit 26a.

If the presence sensor 27 detects the presence of the cheese C in the respective housing 5a, the electronic unit 26a is programmed to operate the pumping device 18 of the corresponding injector device 16.

On the other hand, if the presence sensor 27 does not detect the presence of the cheese C, the pumping device 18 of the corresponding injector device 16 is not operated so that the filling is not dispensed.

The piece of equipment 1 may also comprise cleaning means, not shown in the figures and of a type known to the field technician, adapted to clean the various components of the equipment itself.

The operation of the equipment 1 according to the invention is as follows.

Initially, the cheese C is arranged at its respective supply stations E and the piece of equipment 1 has the container elements 5 at the loading station.

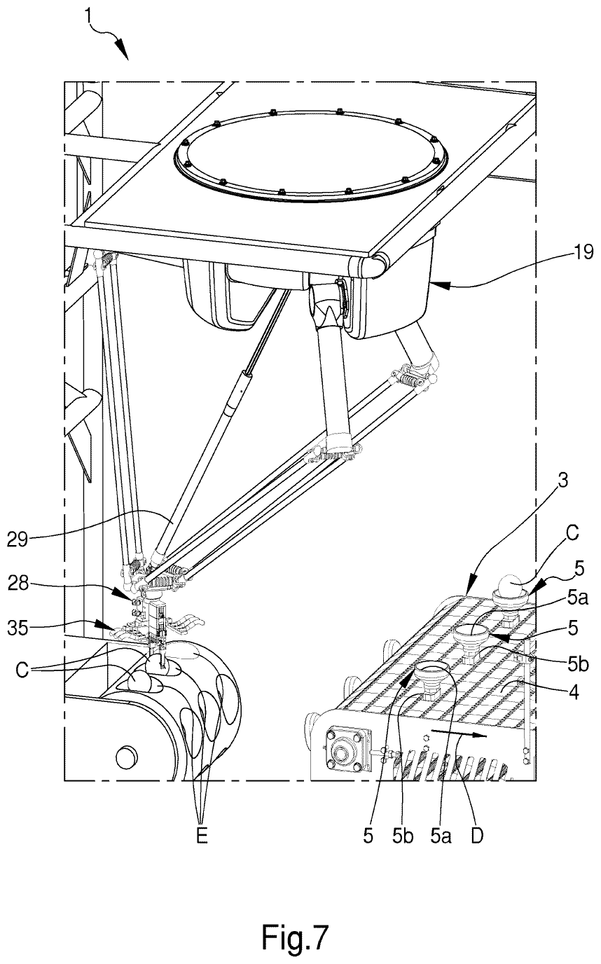

By means of the displacement unit 29, the retaining and holding assembly 28 is brought to the supply station E to pick up a cheese C. The shell bodies 35 are in the opening position and the jaw elements 34 are moved away from each other along the centripetal directions of movement L. The jaw elements 34 are brought closer together along the centripetal directions of movement L to intercept and grip the cheese C (FIG. 7).

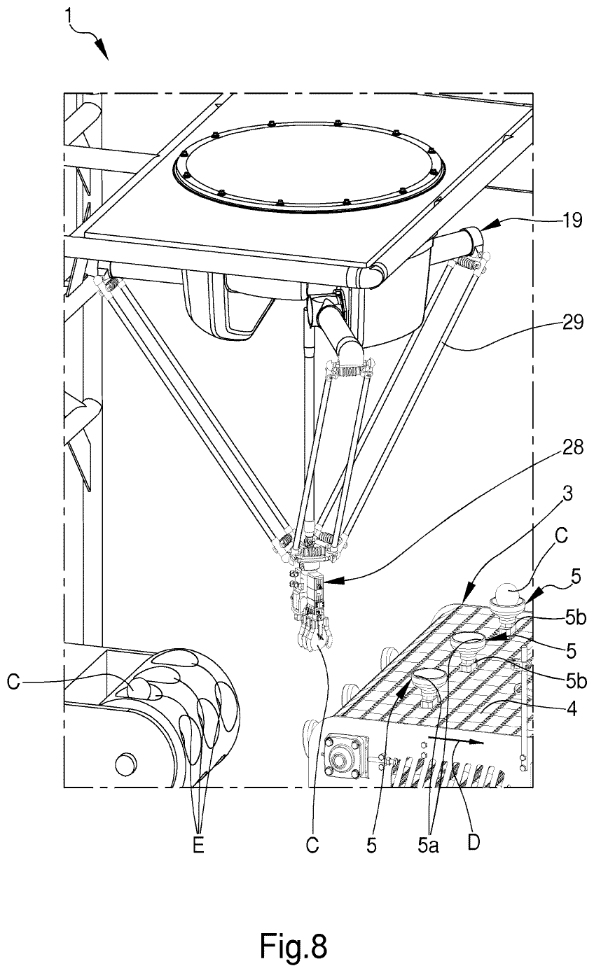

Next, the retaining and holding assembly 28 is moved away from the supply station E and brought towards the supporting means 3. At the same time, the shell bodies 35 are brought to the closing position (FIG. 8).

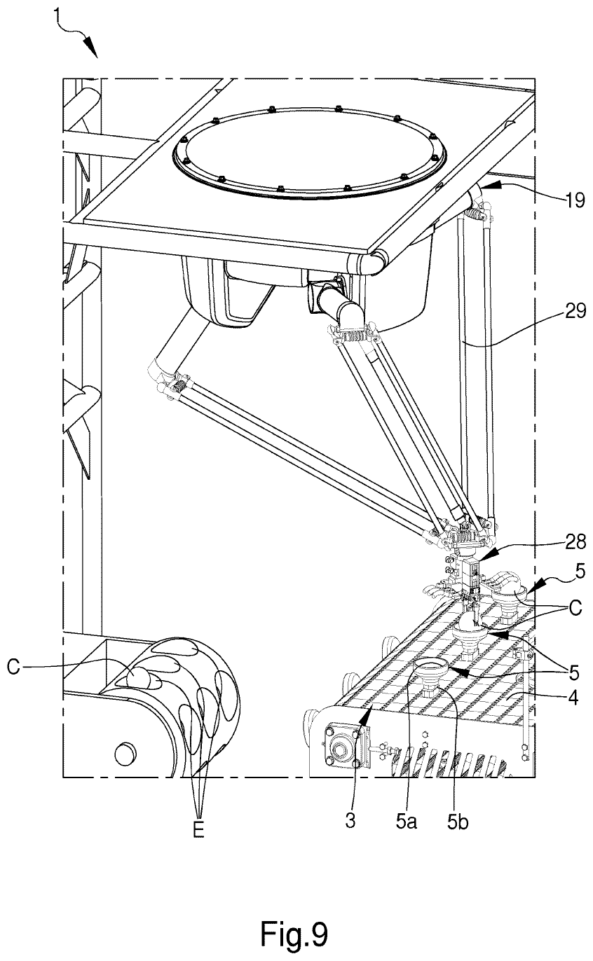

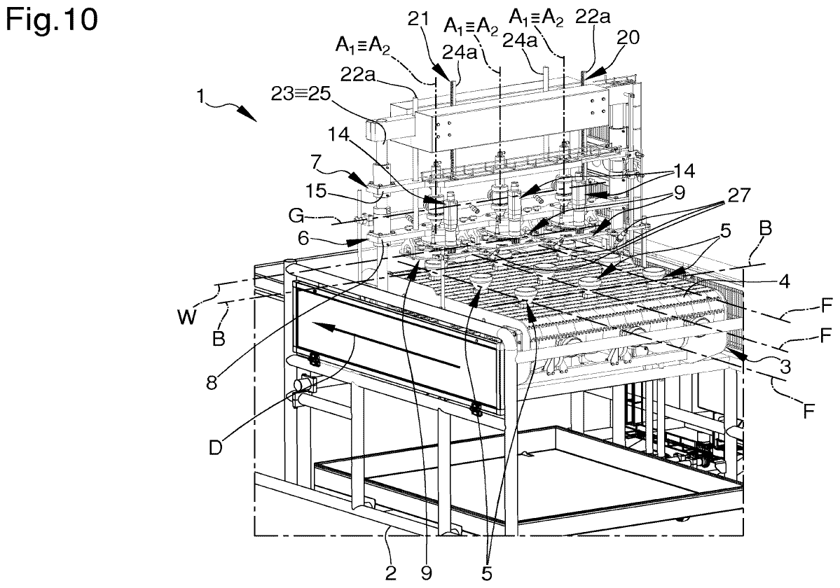

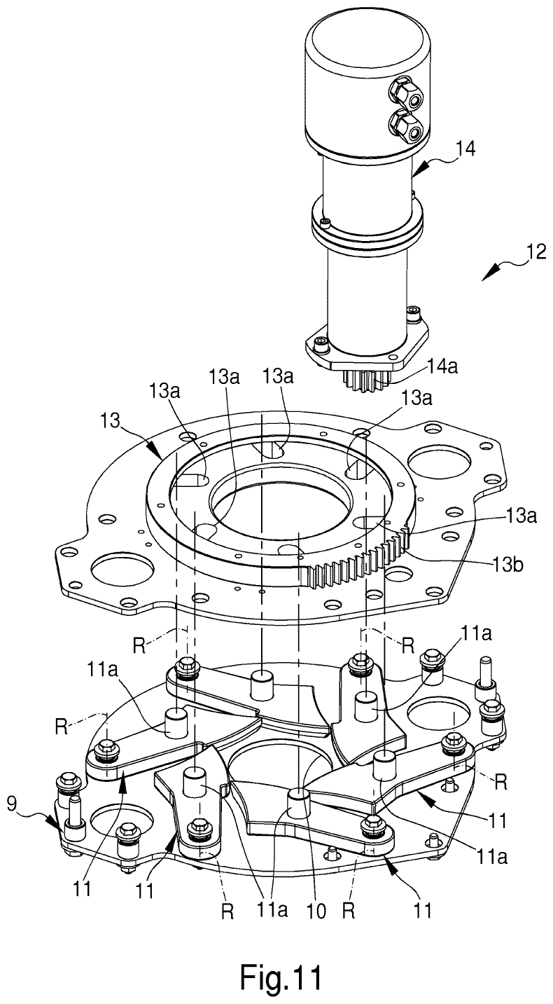

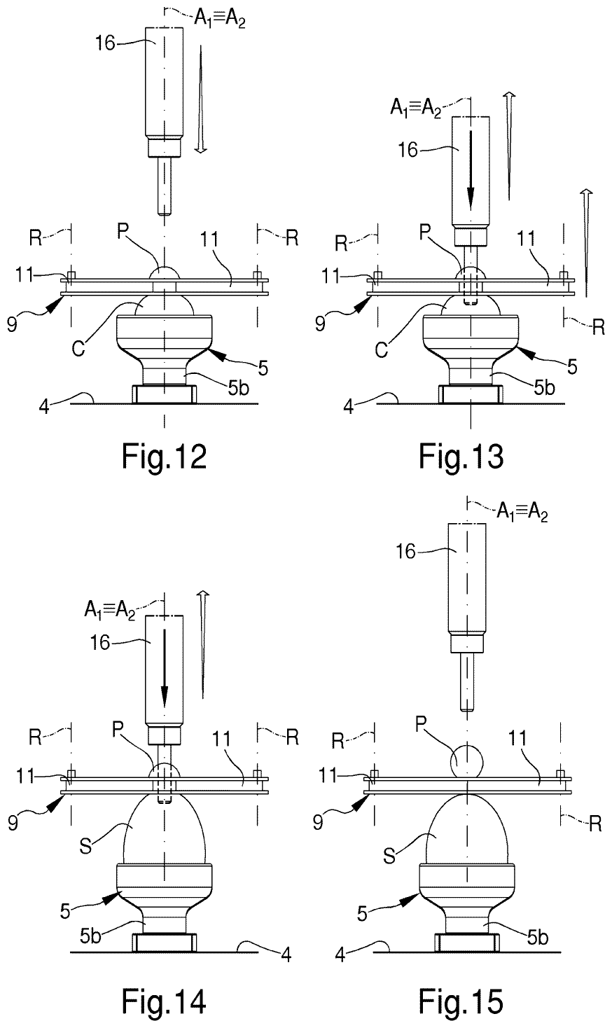

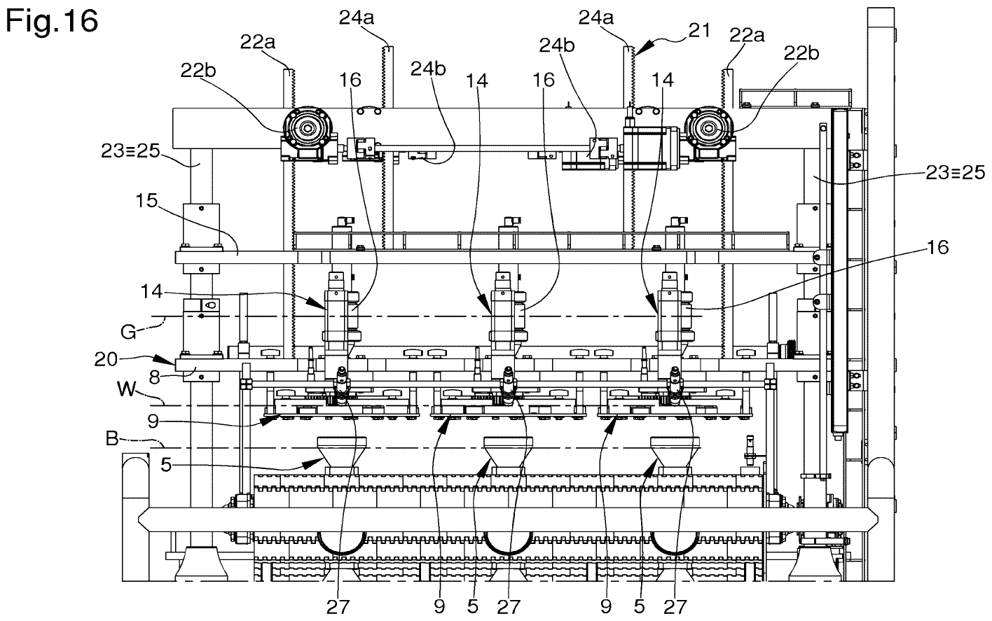

At the supporting means 3, the shell bodies 35 and the jaw elements 34 open to release the cheese C into their respective container element 5 (FIG. 9).

The aforementioned operations are repeated for each row of container elements F.

Next, the container elements 5 are then transferred, by means of the supporting plane 4, along the direction of forward movement D, towards the filling station.

At this point, the mutual movement unit 20 moves the gripping means 6 towards the supporting means 3.

Specifically, the driving unit 22a, 22b brings the diaphragm device 9 close to the cheese C so as to allow the latter to pass through the passage hole 10.

The actuating body 14 of the rotational means 12 is operated by causing the gripping elements 11 to rotate towards the position of work, partly occluding the passage hole 10 and retaining the portion P.

The mutual movement assembly 21 moves the filling means 7 towards the gripping means 6.

Specifically, the motor assembly 24a, 24b moves the injector device 16 close to the diaphragm device 9 so that the injector device itself can be inserted into the cheese C through the portion P.

The pumping device 18 is operated to allow the filling to be dispensed.

During this phase, the mutual movement unit 20 and the mutual movement assembly 21 simultaneously move the gripping means 6 and the filling means 7 away from the supporting means 3 respectively, to facilitate the deformation of the cheese C.

At the end of dispensing, the mutual movement assembly 21 moves the filling means 7 away from the gripping means 6 to allow the extraction of the injector device 16 from the portion P.

At this point, the gripping elements 11 are moved towards the sealing position to exert pressure on the portion P and to close the stuffed cheese S.

If necessary, the gripping elements 11 are further rotated towards the cutting position to remove the portion P from the stuffed cheese S.

Then, the gripping elements 11 are brought towards the home position to release the stuffed cheese S and possibly the removed portion P onto the supporting means 3.

Finally, the supporting plane 4 moves the stuffed cheese S and possibly the removed portion P towards the unloading station.

It has, in practice, been ascertained that the described invention achieves the intended objects, and in particular the fact is emphasized that the equipment for the production of stuffed cheese, particularly burrata cheese, allows reducing working times and related costs.

The presence of a plurality of diaphragm devices and injector devices makes it possible to further reduce working times while simultaneously producing stuffed cheese of different types.

In addition, the equipment according to the invention allows the production of stuffed cheese, particularly burrata cheese, in a fully automated manner so as to free itself from the use of skilled labor.

It also follows that the equipment according to the invention allows the production of stuffed cheese quickly and minimizes the risk of bacterial contamination.

1. Equipment for the production of stuffed cheese, particularly burrata cheese, comprising:
at least one base frame;
supporting means associated with said base frame and adapted to support at least one cheese of the fresh “pasta filata” type;
gripping means associated with said base frame and adapted to retain at least one portion of said cheese;
filling means-associated with said base frame and adapted to inject a filling into said cheese through said portion to obtain a stuffed cheese;
wherein it comprises at least one automated positioning system associated with said base frame and adapted to pick up said cheese from a supply station and to transfer it onto said supporting means, wherein said automated positioning system comprises:
at least one retaining and holding assembly of said cheese;
at least one displacement unit adapted to move said retaining and holding assembly between said supply station and said supporting means.

2. Equipment according to claim 1, wherein that said retaining and holding assembly comprises:
at least one base support associated with said displacement unit;
retaining means associated with said base support and adapted to grasp an upper part of said cheese; and
holding means associated with said base support and adapted to hold and rest a lower part of said cheese once grasped by said retaining means.

3. Equipment according to claim 1, wherein said retaining means comprise at least two jaw elements mutually movable towards a common centre along a relevant centripetal direction of movement.

4. Equipment according to claim 1, wherein said two jaw elements are arranged on opposite sides with respect to said common centre, said centripetal directions of movement being substantially aligned to each other and having opposite directions.

5. Equipment according to claim 1, wherein said retaining means comprise three of said jaw elements arranged around said common centre at angles substantially equal to 120°, said centripetal directions of movement being inclined to each other at angles substantially equal to 120°.

6. Equipment according to claim 1, wherein said holding means comprise at least one shell body rotatable around a substantially horizontal hinge axis, between a closing position, wherein it is moved close to said jaw elements and arranged underneath said lower part of the cheese, and an opening position, wherein it is spaced apart from said jaw elements and is adapted to release said cheese.

7. Equipment according to claim 1, wherein said holding means comprise at least two of said shell bodies rotatable around relevant hinge axes between said closing position and said opening position, wherein said hinge axes are substantially parallel to each other.

8. Equipment according to claim 1, wherein said displacement unit comprises a delta robot.

9. Equipment according to claim 1, wherein
said supporting means comprise:
at least one supporting plane associated with said base frame and movable along a direction of forward movement; and
a plurality of container elements associated with said supporting plane and each adapted to accommodate at least one related cheese;
said supporting plane is discretely movable and adapted to position said container elements between a loading station of said cheese, a filling station of said cheese and an unloading station of said stuffed cheese;
said equipment comprises at least one electronic unit programmable with at least one position of said supply station and with at least one position of at least one of said container elements in said loading station, said electronic unit being operatively connected to said automated positioning system and configured to move said displacement unit depending on said positions.

10. Equipment according to claim 1, wherein it comprises:
at least one mutual movement unit associated with said base frame and adapted to mutually move said supporting means and said gripping means; and
at least one mutual movement assembly associated with said base frame and adapted to mutually move said gripping means and said filling means.
